(19) United States
(12) Patent Application Publication
(10) Pub. No.: US 2009/0153551 A1
(43) Pub. Date: Jun. 18, 2009

(54) METHOD AND APPARATUS FOR TRANSFERRING POSE OF 3-DIMENSIONAL CHARACTERS

(75) Inventors: Ki-young PARK, Daejeon (KR); Il-Kwon JEONG, Daejeon (KR); Byoung Tae CHOI, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/253,648

(22) Filed: Oct. 17, 2008

(30) Foreign Application Priority Data
Dec. 17, 2007 (KR) 10-2007-0132346
Jul. 18, 2008 (KR) 10-2008-0069879

(51) Int. Cl. G06T 15/00

(52) U.S. Cl. 345/419

(57) ABSTRACT

A method for transferring a pose from an original digital character to a newly-created digital character, includes: deriving constraints from a pose of the original character; modeling pose characteristics of each joint of the newly-created character as a probability distribution function having an input variable of a rotation angle of corresponding joint; and modeling pose characteristics of all joints of the newly-created character as a joint probability distribution function having input variables of rotation angles of corresponding joints. The method further includes extracting, based on the joint probability distribution function, the rotation angles of all joints of the newly-created character to thereby create a pose of the newly-created character, the rotation angles satisfying the constraints.

### CROSS-REFERENCE(S) TO RELATED APPLICATION

The present invention claims priority of Korean Patent Application No. 10-2007-0132346, filed on Dec. 17, 2007, and Korean Patent Application No. 10-2008-0069879, filed on Jul. 18, 2008, which are incorporated herein by reference.

### FIELD OF THE INVENTION

The present invention relates to pose transfer between 3D (3-dimensional) digital characters which are in a wide use in digitally produced images such as digital movies, digital television programs, computer graphics, and the like; and, more particularly, to a method and apparatus for automatically transferring a pose of a digital character to another digital character having an articulated figure similar to or different from that of the former one.

This work was supported by the IT R&D program of MIC/IITA. [2007-S-051-01, Software Development for Digital Creature]

### BACKGROUND OF THE INVENTION

As well known in the art, a pose of a digital character which is in a wide use in digital images such as digital movies, digital television programs, computer graphics, and the like, is generally created by using a motion capture system. As for the motion capture system, sensors are attached on a real character, motion images of the character are captured, and data for use in creating a pose of the character are extracted from the images.

However, a method of the motion capture is of high cost, and, also, it is hard to collect pose data of uncontrollable animals such as lions, crocodiles, or the like through the motion capture method.

Further, poses of imaginary characters, which are frequently used in recent but do not exist in a real world, cannot be created using the motion capture method.

For the purpose of overcoming the above drawbacks in the motion capture method, a large number of studies on creation of a pose of a digital character from data on another character once generated are being made. However, the studies still remain at a level restrictedly applicable to a case where articulated figures of two characters are similar to each other, and thus most processes remain manual when articulated figures thereof are different.

A variety of methods for pose transfer of digital characters having articulated figures similar to each other has been proposed. Among of them, two representative methods are a motion retargeting method and an inverse kinematics method.

In the motion retargeting method, positions of hands and feet, a height of a head, and the like are set as constraints required to be met by a given character, and under the constraints, positions and rotation angles of all joints of the character are obtained using various optimization methods. The motion retargeting method is mainly employed in pose transfer of digital characters having same articulated figures.

In the inverse kinematics method, a position of an end effector of a specific joint is fixed, and positions of other joints connected thereto are mathematically calculated. The inverse kinematics method can be employed in pose transfer of digital characters regardless of articulated figures thereof.

However, the motion retargeting method is hard to apply to a case where two digital characters have similar or different articulated figures, and, the inverse kinematics method has a drawback in that motion characteristics of each joint are hard to reflect in a pose of a digital character.

### SUMMARY OF THE INVENTION

In view of the above, the present invention provides a method and apparatus for automatically transferring a pose of a digital character to a natural looking pose of another digital character while maintaining basic pose characteristics of the two characters having similar or different articulated figures. For the purpose, constraints for maintaining basic pose characteristics are derived from a pose of the former character, and, at the same time, pose characteristics of each joint of the latter character are modeled as a probability distribution function. Then, rotation angles of all joints of the latter character are obtained by means of an optimization method, the rotation angles maximizing joint probability of all the joints while satisfying the constraints.

In accordance with one aspect of the invention, there is provided a method for transferring a pose from an original digital character to a newly-created digital character, including:

deriving constraints from a pose of the original character;

modeling pose characteristics of each joint of the newly-created character as a probability distribution function having an input variable of a rotation angle of corresponding joint;

modeling pose characteristics of all joints of the newly-created character as a joint probability distribution function having input variables of rotation angles of corresponding joints; and

extracting, based on the joint probability distribution function, the rotation angles of all joints of the newly-created character to thereby create a pose of the newly-created character, the rotation angles satisfying the constraints.

In accordance with another aspect of the invention, there is provided an apparatus for transferring a pose from an original digital character to a newly-created digital character, including:

a constraints derivation unit for deriving constraints from a pose of the original character;

a probability modeling unit for modeling pose characteristics of each joint of the newly-created character as a probability distribution function having an input variable of a rotation angle of corresponding joint and pose characteristics of all joints of the newly-created character as a joint probability distribution function having input variables of rotation angles of corresponding joints; and

a pose data extraction unit for extracting, based on the joint probability distribution function, the rotation angles of all joints of the newly-created character to thereby create a pose of the newly-created character, the rotation angles satisfying the constraints.

In accordance with the present invention, a pose of a digital character can be automatically transferred to that of another digital character without manual operation, thus greatly reducing a production time and cost for digital images in which various digital characters are appeared.

Further, a pose of a digital character can be transferred, by using an optimization method, to a natural looking pose of another digital character having articulated figures similar to or different from those of the former one, while maintaining basic pose characteristics of the former one and also reflecting pose characteristics of the latter one in the pose thereof. Therefore, productivity of digital images can be greatly increased.

### BRIEF DESCRIPTION OF THE DRAWINGS

The above features of the present invention will become apparent from the following description of embodiments, given in conjunction with the accompanying drawings, in which:

FIG. 1 illustrates a block diagram of an apparatus for transferring a pose between digital characters in accordance with the present invention;

FIG. 2 illustrates a flow chart of a method for transferring a pose between digital characters in accordance with the present invention;

FIGS. 3A and 3B respectively illustrate an exemplary view of a joint structure of a digital character, wherein FIG. 3A illustrates a joint structure of an original character and FIG. 3B illustrates a joint structure of a newly-created character;

FIGS. 4A and 4B respectively illustrate an explanatory view of a length of joint and a height of character, wherein FIG. 4A illustrates the original character and FIG. 4B illustrates the newly-created character; and

FIGS. 5A to 5C respectively illustrate probability distribution functions which can be used in modeling a rotation angle of each joint of the newly-created character, wherein FIG. 5A illustrates normal probability distribution functions, FIG. 5B illustrates exponential probability distribution functions, and FIG. 5C illustrates Rayleigh probability distribution functions.

### DETAILED DESCRIPTION OF THE EMBODIMENT

Hereinafter, embodiments of the present invention will be described in detail with reference to the accompanying drawings, which form a part hereof.

A pose of a newly-created digital character transferred from that of an original digital character needs to be similar to that of the original character, and, also, needs to be controlled easily by a digital image producer who produces digital images such as digital movies, digital television programs, computer graphics, and the like.

For example, when a pose of a man/woman in which he/she bends his/her leg is be transferred to a pose of a horse in which it bents its leg, the pose of the man/woman (original character) needs to be maintained in that of the horse (newly-created character). That is, important pose characteristics such as a position of an end effector, a height of a body, and the like need to be maintained.

In order to meet the above condition that the newly-created character is required to maintain basic pose characteristics of the original character, constraints are derived from the pose of the original character and used in pose transfer between the characters.

As for the pose characteristics, a location and rotation angle of a body are hardly changed in most cases of pose transfer between digital characters, but, instead, locomotion of joints of arms and legs defines the pose characteristics.

Accordingly, the present invention creates, without considering a pose of a body, a pose of joints of arms and legs and attaches thereto the body so as to look natural, thereby creating an entire pose of a newly-created character.

Pose characteristics (locomotion characteristics) of joints depend on types thereof, and, also, joints of the same type have different pose characteristics according to types of characters. For example, joints of human legs bend backward against knees, but joints of horse legs bend forward against knees.

In order to reflect the pose characteristics of joints, the present invention models pose characteristics of each joint of a newly-created character as a probability distribution function.

Modeling the pose characteristics of a joint includes selecting a widely used probability distribution function and setting control variables for the probability distribution function based on actually measured data. Here, if the actually measured data does not exist, a user can set the control variables to arbitrary values in consideration of the pose of the character. Through this modeling, the newly-created character can have a natural looking pose.

Meanwhile, if derivation procedure of the constraints and modeling procedure of the pose characteristics are carried out sequentially, complexity in implementation will be increased and, further, the constraints cannot be satisfied throughout the entire procedures.

Therefore, the present invention performs the above-described two procedures simultaneously, thereby creating a natural looking pose of a newly-created character via efficient computation while maintaining basic pose characteristics of an original character.

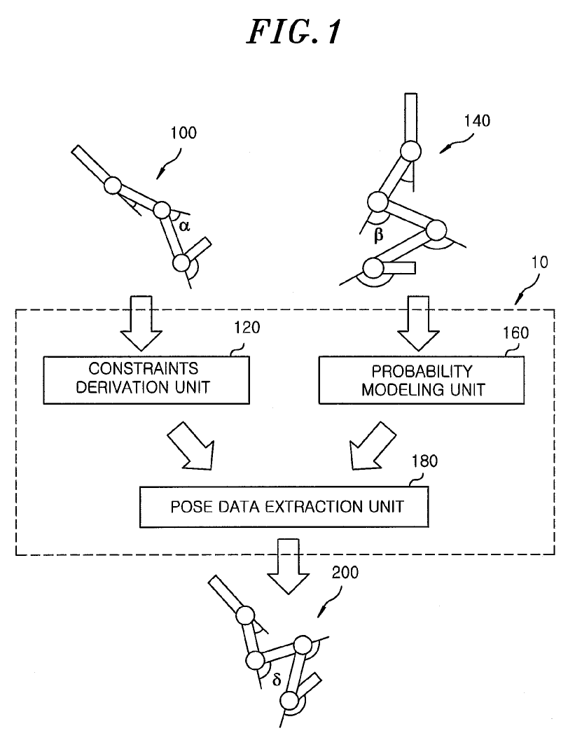

Referring now to FIG. 1, there is illustrated a block diagram of an apparatus for transferring a pose between digital characters in accordance with the present invention.

As shown in FIG. 1, an apparatus 10 for transferring a pose between digital characters which are in a wide use in digital images such as digital movies, digital television programs, computer graphics, and the like includes: a constraints derivation unit 120 for deriving constraints from pose characteristics 100 of an original character, necessary for maintaining basic pose characteristics of the original character; a probability modeling unit 160 for modeling pose characteristics 140 of each joint of a newly-created character as a probability distribution function to obtain a joint probability distribution function of all joints of the newly-created character; and a pose data extraction unit 180 for extracting, by using an optimization method, pose data to create a pose 200 of all joints of the newly-created character, wherein the pose data maximizes the joint probability distribution function obtained by the probability modeling unit 160 while satisfying the constraints derived by the constraints derivation unit 120.

Below, the method for transferring a pose between digital characters in accordance with the present invention will be explained.

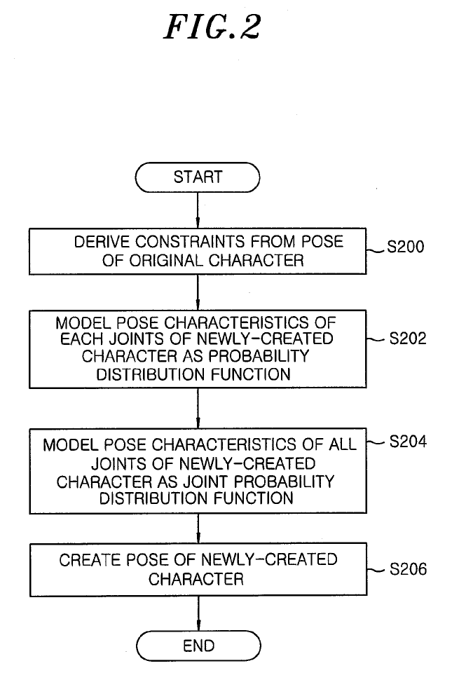

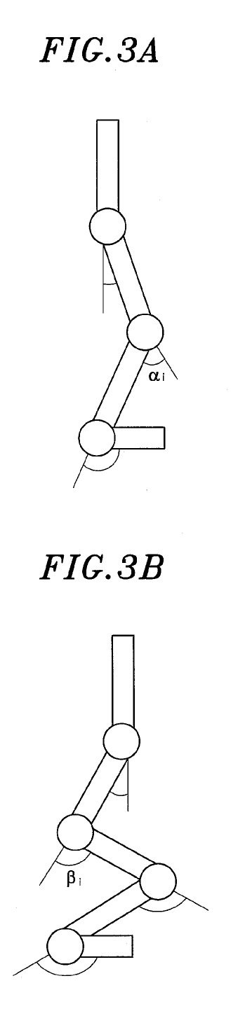

FIG. 2 illustrates a flow chart of a method for transferring a pose between digital characters in accordance with the present invention. FIGS. 3A and 3B respectively illustrate an exemplary view of a joint structure of a digital character, wherein FIG. 3A illustrates a joint structure of an original character and FIG. 3B illustrates a joint structure of a newly-created character.

Rotation angle of each joint of the original character changes with an elapse of time, thus forming a motion of the original character. As for the newly-created character whose motion is to be created, only a joint structure is given and changes of rotation angle of each joint is not given firstly, thus the newly-created character is in a stationary motion.

Reference symbol αᵢ in FIG. 3A represents a rotation angle of an iₜₕ joint of the original character at a specific time T. A unique pose of the original character at the time T can be determined by rotation angles αᵢ for 1≦i≦N (N is an integer).

Reference symbol β, in FIG. 3B represents a rotation angle of an iₜₕ joint of the newly-created character. The object of the present invention is to automatically calculate rotation angles βᵢ for 1≦i≦M (M is an integer) by using the rotation angles αᵢ, thereby creating a pose of the newly-created character corresponding to the rotation angles αᵢ of the original character.

Herein, poses of the original character and the newly-created character can be represented by the union of sets of rotation angles αᵢ and βᵢ, respectively. Because joint structures of the original character and the newly-created character are different from each other, the integers M and N are different in general. However, if there are correspondencies between the joints of the two characters, the motion of the original character can be copied to the newly-created character.

Below, the method to obtain the rotation angles βᵢ of the newly-created character by using the rotation angles αᵢ of the original character will be described in detail.

First, the constraints derivation unit 120 derives constraints from the pose characteristics 100 of the original character (step S200).

A first constraint is that the sum

$${\sum }_{i} {α}_{i}$$

of the rotation angles αᵢ of the original character is equal to the sum

$${\sum }_{i} {β}_{i}$$

of the rotation angles βᵢ of the newly-created character, as in Equation 1.

$${\sum }_{i} {α}_{i} = {\sum }_{i} {β}_{i} \qquad Equation 1$$

The first constraint is a necessary condition to ensure that a direction of each joint of the newly-created character is maintained identical to a direction of a corresponding joint of the original character.

The first constraint represented by Equation 1 means that a slope of a straight line between a start point and an end point of each joint of the newly-created character is identical to that of the original character.

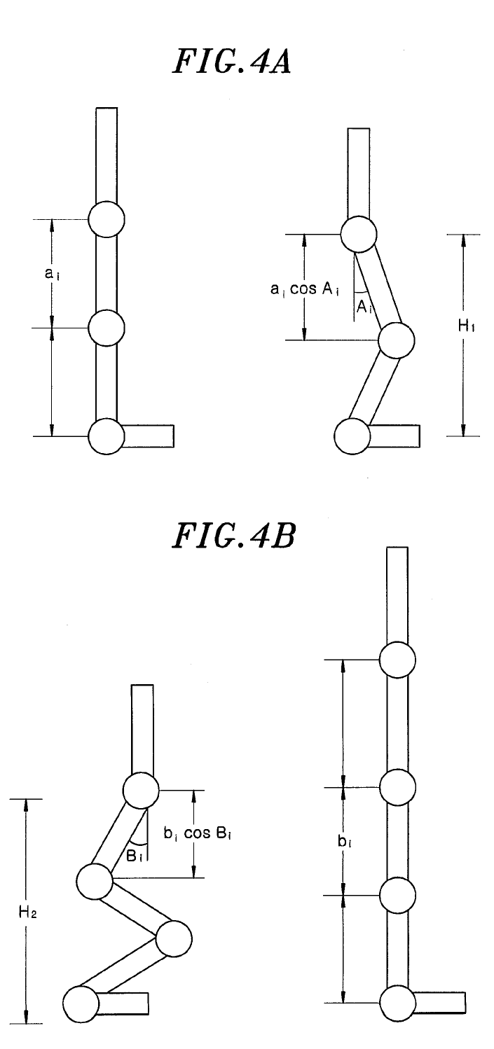

FIGS. 4A and 4B respectively illustrate an explanatory view of a length of joint and a height of character, wherein FIG. 4A illustrates the original character and FIG. 4B illustrates the newly-created character.

Reference symbol aᵢ in FIG. 4A represents a length of the iₜₕ joint of the original character, and reference symbol bᵢ in FIG. 4B represents a length of the iₜₕ joint of the newly-created character. In addition, reference symbol H₁ in FIG. 4A represents a height of the original character, and reference symbol H₂ in FIG. 4B represents a height of the newly-created character.

A second constraint is that a relative height

$${\sum }_{i} {α}_{i} \text{:} {H}_{1}$$

of the original character is equal to a relative height

$${\sum }_{i} {b}_{i} \text{:} {H}_{2} \qquad$$

of the newly-created character, as in Equation 2.

$${\sum }_{i} {a}_{i} \text{:} {H}_{1} = {\sum }_{i} {b}_{i} \text{:} {H}_{2} \qquad Equation 2$$

The second constraint represented by Equation 2 means that, even if the lengths of joints of the newly-created character are longer or shorter than those of the original character, a ratio between sum of the lengths of joints and the height of the newly-created character is kept identical to a ratio between sum of the lengths of joints and the height of the original character. In other words, if the original character bends its joints largely, the newly-created character also bends its joints largely in proportion to the lengths of joints thereof.

In Equation 2, the heights H₁ and H₂ can be obtained by Equations 3-1 and 3-2, respectively,

$$\begin{matrix}{H}_{1} = {\sum }_{i} {a}_{i} cos {A}_{i} & Equation 3 \text{-} 1 \\ {H}_{2} = {\sum }_{i} {b}_{i} cos {B}_{i} & Equation 3 \text{-} 2\end{matrix}$$

wherein Aᵢ represents an angle between the iₜₕ joint of the original character and a line perpendicular to a reference surface, and Bᵢ represents an angle between the iₜₕ joint of the newly-created character and a line perpendicular to the reference surface.

Further, the angles Aᵢ and Bᵢ can be obtained by Equations 4-1 and 4-2, respectively.

$$\begin{matrix}{A}_{i} = {\sum }_{j = 1}^{i} {α}_{j} & Equation 4 \text{-} 1 \\ {B}_{i} = {\sum }_{j = 1}^{i} {β}_{j} & Equation 4 \text{-} 2\end{matrix}$$

After the first and the second constraint are derived by the constraints derivation unit 120 in the step S200, the rotation angles βᵢ of the newly-created character are calculated by using the rotation angles αᵢ of the original character under the condition that the rotation angles βᵢ satisfy the first and the second constraint.

In this case, since the number of variables (rotation angles to be obtained) is greater than the number of the constraints, there can be an infinite number of solutions. Accordingly, in order to obtain an optimal solution, the probability modeling unit 160 models the pose characteristics 140 of each joint of the newly-created character as a probability distribution function ƒₘ(θ) having an input variable of the rotation angle θ, as in Equation 5 (step S202). The probability distribution function in Equation 5 represents an angle by which a joint is bent most naturally.

ƒₘ(θ)=Pr(β=θ) Equation 5

Here, the probability distribution function ƒₘ(θ) can

be obtained by collecting pose data of a real character, or, can be a user-defined probability distribution function in which an anatomical structure and pose characteristics of an imaginary character are reflected.

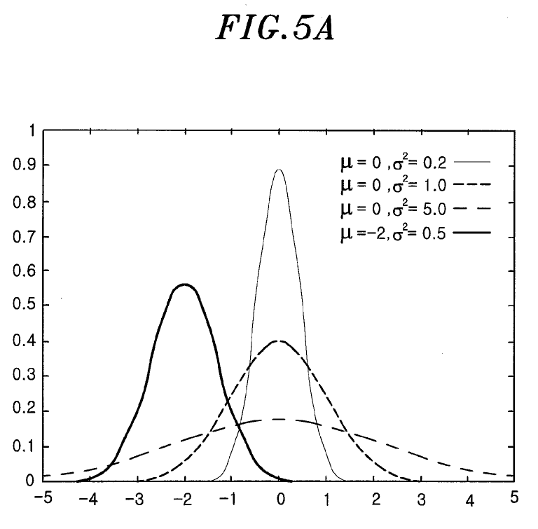

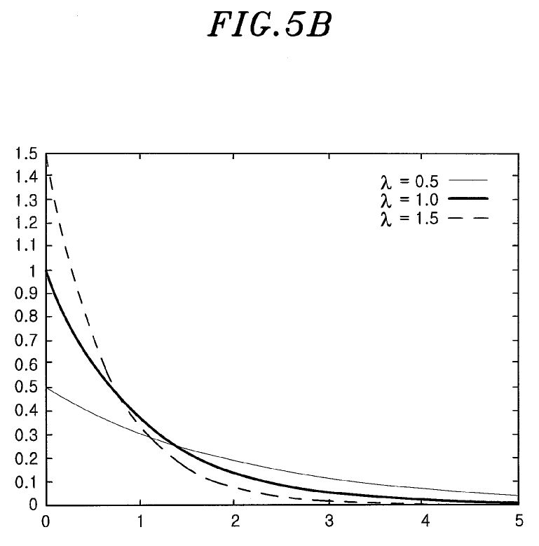

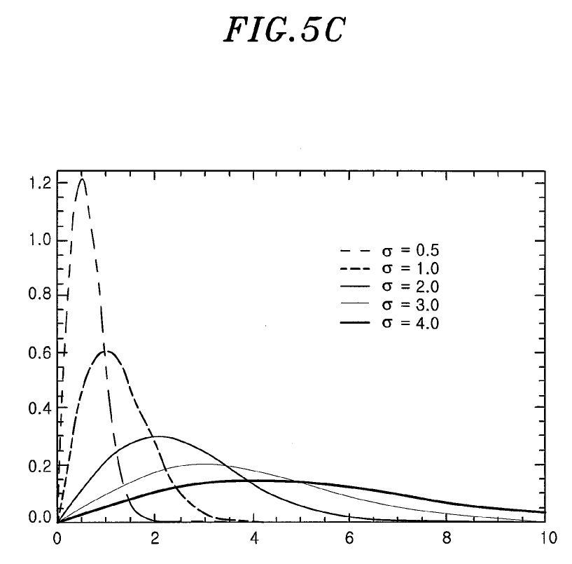

The probability distribution function ƒₘ(θ) can be selected among existing functions such as a normal probability distribution function as in Equation 6-1 (see, FIG. 5A), an exponential probability distribution function as in Equation 6-2 (see, FIG. 5B), a Rayleigh probability distribution function as in Equation 6-3 (see, FIG. 5C), a Gaussian mixture probability distribution function as in Equation 6-4, and the like. In Equation 6-4, G(x;μ,σ) represents a normal probability distribution function.

$$\begin{matrix}f ( x ; μ , σ ) = \frac{1}{\sqrt{2 π {σ}^{2}}} {e}^{- {( x - μ )}^{2} / 2 {σ}^{2}} & Equation 6 \text{-} 1 \\ f ( x ; λ ) = \{ \begin{matrix}λ {e}^{- λ x} , & x \geq 0 \\ 0 , & x < 0\end{matrix} & Equation 6 \text{-} 2 \\ f ( x ; σ ) = \frac{x {e}^{- {x}^{2} / 2 {σ}^{2}}}{{σ}^{2}} & Equation 6 \text{-} 3 \\ f ( x ; μ , σ ) = {\sum }_{i} G ( x ; {μ}_{i} , {σ}_{i} ) & Equation 6 \text{-} 4\end{matrix}$$

Alternatively, any probability distribution function ƒ(x) satisfying a condition as in Equation 7 can be used in modeling the rotation angle of each joint of the newly-created character. That is, a user can arbitrarily select and use a probability distribution function according to characteristics of each joint.

$${\int }_{- ∞}^{∞} f ( x ) d x = 1 \qquad Equation 7$$

After the probability distribution function is selected as described above, control variables of each probability distribution function are separately set according to types of the newly-created character and corresponding joint, as in Equation 8.

Normal:μ,σ

Exponential:λ

Rayleigh:σ

Gaussian mixture:μ={μ₁, . . . , μ_{N}}, σ={σ₁, . . . , σ_{N}} Equation 8

For example, if the normal probability distribution function in Equation 6-1 is used, the variables μ and σ need to be set to coincide with characteristics of a real joint. That is, if the joint is unfolded and has a narrow rotation radius, the variable μ needs to be set to zero and the variable σ needs to be set to an extremely small value.

After the probability distribution function and the control variables have been determined, probability that the rotation angle βᵢ of the iₜₕ joint of the newly-created character becomes θ can be calculated by Equation 9,

Pr(βᵢ=θ)=ƒᵢ(θ) Equation 9

wherein, ƒᵢ(θ) represents a probability distribution function corresponding to the iₜₕ joint of the newly-created character.

Because probability that a joint is unfolded or folded by 90° can be calculated by using Equation 9, probability that the newly-created character takes a specific pose can be obtained.

Now, the probability modeling unit 160 models probability for the rotation angles of M joints of the newly-created character as a joint probability distribution function, as in Equation 10 (step S204).

Pr(β₁=θ₁, . . . , β_{M}=θ_{M})=ƒ_{1, . . . , M}(θ₁, . . . , θ_{M}) Equation 10

Here, if the rotation angles of the joints are independent from each other, the joint probability distribution function of the rotation angles of M joints of the newly-created character can be calculated as in Equation 11.

$${f}_{1 , … , M} ( {θ}_{1} , … , {θ}_{M} ) = {\prod }_{i} {f}_{i} ( {θ}_{i} ) \qquad Equation 11$$

Since the probability distribution function ƒᵢ(θ) is a logarithmic probability distribution function, the rotation angles {β₁, . . . , β_{M}} which maximize the joint probability distribution function Πᵢƒᵢ(θᵢ) can be calculated as in Equation 12.

$$\begin{matrix}\{ {β}_{1} , … , {β}_{M} \} = arg max {\prod }_{i} {f}_{i} ( {θ}_{i} ) \\ = arg max {\sum }_{i} log {f}_{i} ( {θ}_{i} )\end{matrix} \qquad Equation 12$$

The pose data extraction unit 180 extracts, by using Equation 12, the rotation angles which maximize the joint logarithmic probability distribution function obtained by the probability modeling unit 160 in the step S204 while satisfying the constraints derived by the constraints derivation unit 120 in the step S200, thereby creating the pose 200 for all joints of the newly-created character (step S206).

While the invention has been shown and described with respect to the embodiments, it will be understood by those skilled in the art that various changes and modification may be made without departing from the scope of the invention as defined in the following claims.

What is claimed is:

1. A method for transferring a pose from an original digital character to a newly-created digital character, comprising:
deriving constraints from a pose of the original character;
modeling pose characteristics of each joint of the newly-created character as a probability distribution function having an input variable of a rotation angle of corresponding joint;
modeling pose characteristics of all joints of the newly-created character as a joint probability distribution function having input variables of rotation angles of corresponding joints; and
extracting, based on the joint probability distribution function, the rotation angles of all joints of the newly-created character to thereby create a pose of the newly-created character, the rotation angles satisfying the constraints.

2. The method of claim 1, wherein the constraints include that a sum of rotation angles of all joints of the original character is equal to a sum of the rotation angles of all joints of the newly-created character and a slope of a straight line between a start point and an end point of each joint of the newly-created character is identical to that of the original character, as in Equation 1:
$${\sum }_{i} {α}_{i} = {\sum }_{i} {β}_{i} \qquad Equation 1$$
wherein αᵢ represents a rotation angle of an iₜₕ joint of the original character and βᵢ represents a rotation angle of an iₜₕ joint of the newly-created character.

3. The method of claim 1, wherein the constraints include that a relative height of the original character is equal to a relative height of the newly-created character and, if the lengths of joints of the newly-created character are longer or shorter than those of the original character, a ratio between sum of lengths of joints and height of the newly-created character is kept identical to a ratio between sum of lengths of joints and height of the original character, as in Equation 2:
$${\sum }_{i} {a}_{i} \text{:} {H}_{1} = {\sum }_{i} {b}_{i} \text{:} {H}_{2} \qquad Equation 2$$
wherein, aᵢ and H₁ respectively represent a length of an iₜₕ joint of the original character and a height of the original character, and, bᵢ and H₂ respectively represents a length of an iₜₕ joint of the newly-created character and a height of the newly-created character.

4. The method of claim 3, wherein the heights H₁ and H₂ can be obtained by Equations 3-1 and 3-2, respectively:
$$\begin{matrix}{H}_{1} = {\sum }_{i} {a}_{i} cos {A}_{i} & Equation 3 \text{-} 1 \\ {H}_{2} = {\sum }_{i} {b}_{i} cos {B}_{i} & Equation 3 \text{-} 2\end{matrix}$$
wherein Aᵢ represents an angle between the iₜₕ joint of the original character and a line perpendicular to a reference surface, and Bᵢ represents an angle between the iₜₕ joint of the newly-created character and a line perpendicular to the reference surface.

5. The method of claim 4, wherein the angles Aᵢ and Bᵢ can be obtained by Equations 4-1 and 4-2, respectively:
$$\begin{matrix}{A}_{i} = {\sum }_{j = 1}^{i} {α}_{j} & Equation 4 \text{-} 1 \\ {B}_{i} = {\sum }_{j = 1}^{i} {β}_{j} & Equation 4 \text{-} 2\end{matrix}$$
wherein αᵢ represents the rotation angle of the iₜₕ joint of the original character and βᵢ represents the rotation angle of the iₜₕ joint of the newly-created character.

6. The method of claim 1, wherein the probability distribution function of each joint of the newly-created character is obtained by collecting pose data of the newly-created character if the newly-created character is a real character, and, by reflecting an anatomical structure and the pose characteristics of the newly-created character if the newly-created character is an imaginary character.

7. The method of claim 6, wherein the probability distribution function of each joint of the newly-created character is a function ƒ(x) satisfying Equation 5:
$${\int }_{- ∞}^{∞} f ( x ) d x = 1 \qquad Equation 5$$
wherein x is an input variable representing the rotation angle of corresponding joint of the newly-created character.

8. The method of claim 6, wherein the probability distribution function of each joint of the newly-created character is a probability distribution function selected from a group including a normal probability distribution function ƒ(x;μ,σ) as in Equation 6-1, an exponential probability distribution function ƒ(x;λ) as in Equation 6-2, a Rayleigh probability distribution function f(x;σ) as in Equation 6-3, and a Gaussian mixture probability distribution function ƒ(x;μ,σ) as in Equation 6-4:
$$\begin{matrix}f ( x ; μ , σ ) = \frac{1}{\sqrt{2 π {σ}^{2}}} {e}^{- {( x - μ )}^{2} / 2 {σ}^{2}} & Equation 6 \text{-} 1 \\ f ( x ; λ ) = \{ \begin{matrix}λ {e}^{- λ x} , & x \geq 0 \\ 0 , & x < 0\end{matrix} & Equation 6 \text{-} 2 \\ f ( x ; σ ) = \frac{x {e}^{- {x}^{2} / 2 {σ}^{2}}}{{σ}^{2}} & Equation 6 \text{-} 3 \\ f ( x ; μ , σ ) = {\sum }_{i} G ( x ; {μ}_{i} , {σ}_{i} ) & Equation 6 \text{-} 4\end{matrix}$$
wherein G(x;μ,σ) represents a normal probability distribution function.

9. The method of claim 8, wherein modeling pose characteristics of each joint of a newly-created character includes separately setting control variables for the probability distribution function of each joint of the newly-created character according to types of the newly-created character and corresponding joint: μ and σ in case of the normal probability distribution function; λ in case of the exponential probability distribution function; σ in case of the Rayleigh probability distribution function; and μ={μ₁, . . . , μ_{N}} and σ={σ₁, . . . , σ_{N}} in case of the Gaussian mixture probability distribution function.

10. The method of claim 1, wherein probability that the rotation angle βᵢ of an iₜₕ joint of the newly-created character becomes θ is calculated by Equation 7:
Pr(β₁=θ)=ƒᵢ(θ) Equation 7
wherein, ƒᵢ(θ) represents a probability distribution function corresponding to the iₜₕ joint of the newly-created character.

11. The method of claim 10, wherein probability that the rotation angles {β₁, . . . , β_{M}} of M joints of the newly-created character become {θ₁, . . . , θ_{M}} is calculated by Equation 8:
Pr(η₁=θ₁, . . . , β_{M}=θ_{M})=ƒ_{1, . . . , M}(θ₁, . . . , θ_{M}) Equation 8
wherein ƒ_{1, . . . , M}(θ₁, . . . , θ_{M}) represents the joint probability distribution function corresponding to the M joints of the newly-created character.

12. The method of claim 11, wherein, if the rotation angles {β₁, . . . , β_{M}} are independent from each other, the joint probability distribution function is calculated by Equation 9:
$$Pr ( {β}_{1} = {θ}_{1} , … , {β}_{M} = {θ}_{M} ) = {\prod }_{i} {f}_{i} ( {θ}_{i} ) . \qquad Equation 9$$

13. The method of claim 12, wherein the rotation angles {β₁, . . . , β_{M}} of the M joints of the newly-created character can be obtained by Equation 10:
$$\begin{matrix}\{ {β}_{1} , … , {β}_{M} \} = arg max {\prod }_{i} {f}_{i} ( {θ}_{i} ) \\ = arg max {\sum }_{i} log {f}_{i} ( {θ}_{i} ) .\end{matrix} \qquad Equation 10$$

14. An apparatus for transferring a pose from an original digital character to a newly-created digital character, comprising:
a constraints derivation unit for deriving constraints from a pose of the original character;
a probability modeling unit for modeling pose characteristics of each joint of the newly-created character as a probability distribution function having an input variable of a rotation angle of corresponding joint and pose characteristics of all joints of the newly-created character as a joint probability distribution function having input variables of rotation angles of corresponding joints; and
a pose data extraction unit for extracting, based on the joint probability distribution function, the rotation angles of all joints of the newly-created character to thereby create a pose of the newly-created character, the rotation angles satisfying the constraints.

15. The apparatus of claim 14, wherein the constraints include that a sum of rotation angles of all joints of the original character is equal to a sum of the rotation angles of all joints of the newly-created character; a slope of a straight line between a start point and an end point of each joint of the newly-created character is identical to that of the original character; a relative height of the original character is equal to a relative height of the newly-created character; and, if the lengths of joints of the newly-created character are longer or shorter than those of the original character, a ratio between sum of lengths of joints and height of the newly-created character is kept identical to a ratio between sum of lengths of joints and height of the original character.

16. The apparatus of claim 14, wherein the probability modeling unit models the pose characteristics as the probability distribution function by collecting pose data of the newly-created character if the newly-created character is a real character, and, by reflecting an anatomical structure and the pose characteristics of the newly-created character if the newly-created character is an imaginary character.
